(19) United States
(12) Patent Application Publication
(10) Pub. No.: US 2012/0073471 A1
(43) Pub. Date: Mar. 29, 2012

(54) USE OF A WAXY COMPOSITION AS A COATING OF SURFACES FOR IMPROVING THE CLEANABILITY THEREOF

(75) Inventor: Hans Pfau, Bad Pyrmont (DE)

(73) Assignee: DINOL GMBH, Ludge (DE)

(21) Appl. No.: 13/322,386

(22) PCT Filed: May 26, 2010
(86) PCT No.: PCT/EP2010/003182

§ 371 Date: Nov. 23, 2011

(30) Foreign Application Priority Data
Jun. 9, 2009 (DE) 20 2009 008 205.9

(51) Int. Cl. C09D 191/06

(52) U.S. Cl. 106/268

(57) ABSTRACT

Use of a wax-containing composition as a surface coating in order to improve the cleanability of the surfaces, whereby the composition comprises: alkyd resin as binding agent at a concentration in the range of 20-60% by weight, sulfonates at a concentration in the range of 10-30% by weight, a wax, in particular a micro-wax at a concentration in the range of 1-10% by weight, and aliphatic hydrocarbon-based solvent at a concentration in the range of 10-50% by weight.

The invention relates to the use of special wax-containing compositions as surface coating, in particular for surfaces of devices that are regularly contaminated by paint or plastic materials.

Such devices are present, e.g., in paint finishing lines or enameling plants or enameling stations. This may concern, e.g. floor surfaces, SKIDS, grating, exhaust air facilities or the like. The removal of contaminating paint from said devices, often called paint stripping, is a major issue.

Another potential field of application of the invention are devices that are used in forming processes for plastic materials, such as, e.g., injection molding, deep-drawing, etc.

In the case of contaminating paint, paint stripping usually involves the use of a high-pressure water jet at a pressure of up to 3,000 bar. Cleaning with a high-pressure water jet of said type is hazardous for the cleaning staff. Moreover, it subjects the devices that are thus cleaned to increased wear and tear. Somewhat less severe, but basically similar conditions, are used in the cleaning of molds and the like contaminated by plastic materials. The cleaning usually involves the use of a water jet at 1,500 bar in this case.

One way this problem is addressed according to the prior art is to provide the surfaces with a coating that is designed to ease the cleaning of contaminations, e.g. contamination caused by paint.

The UK patent application, GB 2 227 187 A1, discloses a method for pre-treatment of, e.g., a carrier grating of a painting device using, e.g., ethanol or glycerol. However, said type of pre-treatment fails to provide a coating that would survive multiple cleaning cycles.

Also to be mentioned here are DE 10 2005 037 338 A1 as it relates to a particulate anti-stick coating and EP 1 591 500 B1 as it addresses a special anti-graffiti coating based on a urethane acrylate resin.

Another coating for prevention of contamination is described in DE 10 2004 053 384 A1. Said coating contains an organo-functional silane system.

Teflon-based coatings are known especially for paint finishing lines. From the utility model, DE 202 04 460 U1, it is known that deflection rollers of conveyor belts can be coated appropriately in order to reduce their adhesion with respect to color pigments. A similar coating, which is again Teflon-based, is described for hooks of free-running paint finishing plants in utility model G 86 24 980.0.

And lastly, a coating is known from DE 20 2005 005 698 A1 that can be used to specifically coat devices of paint finishing lines and which is said to render contaminating paint easier to clean. This relates to a plasma polymer, oxygen-, carbon-, and silicon-containing coating that is relatively laborious to implement.

Based on the prior art, it is the object of the invention to provide a less expensive option for a durable and easy-to-clean coating of surfaces at risk.

This is attained by the use of the composition specified in claim 1 as a coating of surfaces.

The composition comprises:
1. alkyd resin as binding agent at a concentration in the range of 20-60% by weight
2. sulfonates at a concentration in the range of 10-30% by weight
3. a wax, in particular a micro-wax at a concentration in the range of 1-10% by weight, and
4. aliphatic hydrocarbon-based solvent at a concentration in the range of 10-50% by weight

The composition, if used according to the invention, has surprisingly been found to form a coating from which contamination, e.g. contaminating paint or plastic materials, can be cleaned off with substantially less effort and which concurrently has high durability, including with respect to the elevated temperatures of up to 250° C. as used in paint finishing lines.

The durability of the coating is presumed to be based on the special combination of solvent-alkyd resin, whereas the combination of wax and sulfonate presumably imparts the coating with adhesion-reducing properties, without being limited by this presumption.

Preferably, the alkyd resin that is used as binding agent is a urethane oil. Preferred alkyd resin concentrations are in the range between 35 and 50% by weight.

Sulfonates are preferably used at a concentration in the range between 15 and 25% by weight. Preferably, an organic calcium sulfonate is used as sulfonate in the composition. However, other compounds from said group are obviously conceivable just as well.

It is preferred to use white spirit as aliphatic hydrocarbon-based solvent. Preferred solvent concentrations are in the range between 20 and 30% by weight.

The wax is provided, in particular, at a concentration between 2 and 6% by weight.

The wax contained in the composition that is used according to the invention preferably is a micro-wax. Micro-waxes having a melting range of 60-90° C. are particularly preferred.

However, paraffin resins having a solidification range of 50-90° C. and polyethylene waxes having a melting range of 95-135° C. are also well-suited.

The composition shall not be limited to the components specified thus far. Obviously, it is feasible to add additional components as well.

Accordingly, one embodiment provides, e.g., a drying agent for the alkyd resin to be added at a concentration of less than 1% by weight. This can, e.g., be cobalt octoate.

Moreover, paraffins may be added at a concentration in the range between 1 and 10% by weight in order to increase the adhesion-resistant properties. For example paraffin is particularly well-suited.

Moreover, an embodiment provides the composition to contain anti-skinning agent at a concentration of less than 1% by weight.

The surfaces to be protected can be coated by means of any common procedure, e.g. by spraying, immersion or any other application method. Usually, the coating is ready for use after a drying phase of 4 hours.

The coating used according to the invention can be used to provide surfaces made of different materials with the desired adhesion-reducing properties. Contaminations, in particular contaminating paint or plastic materials, can be cleaned off surfaces coated as described above using a water jet at pressures between 120 and 500 bar.

The composition can be applied not only to metallic surfaces, but also to surfaces made of plastic, wood, and even concrete. In either case, it forms an adhesion-reducing coating that reduces the surface adhesion of, e.g., contaminating paint or excess plastic materials.

The term, paint, is to be interpreted broadly. It can include common paints such as are used, e.g., in the automotive industry. But it is conceivable that the term also includes all other paints and materials that are used in technical or non-technical applications. Used according to the invention, the composition is also suitable as a coating of devices in the printing or woodworking industry that might be contaminated by printing paint. Said devices, e.g. printing presses, can also be cleaned more easily provided they are coated by the composition.

Due to the fact that the composition can be used not only to coat metal surfaces, but e.g. concrete surfaces as well, an additional use of the composition as anti-graffiti coating is conceivable as well.

Also the term, plastic materials, should also be interpreted broadly. Said term is to cover all common starting materials for forming processes. Contamination may occur in said processes in particular due to an excess of the plastic material to be formed being used, but obviously by other means as well. The term, contamination, shall encompass all ways in which undesired adhesion of plastic residues on devices may occur in said processes.

Another essential advantage of the composition according to the invention is that it forms a durable, including temperature-resistant, coating. Tests conducted by the applicant have shown that the coating is stable, i.e. imparts the desired properties to the coated surface, over a period of at least 20 common cleaning cycles as used in painting devices.

Another advantage of the composition, used according to the invention as a coating, is that it does not release any substances interfering with paint wetting. This is an important pre-requisite for its use in paint finishing lines. It is absolutely essential in paint finishing lines that no parts of a coating detach from the surfaces and, e.g., drop onto the object to be painted during the painting process. It is just as essential that a composition that is used as a coating contains no substances that may be released as a gas or liquid from the coating to then interfere with the painting process. The composition used according to the invention has surprisingly been found to release no substances that interfere with the painting process and, due to its durability, is not associated with a risk of particles detaching from it. Presumably, this is related to the paint-repelling components being embedded particularly firmly in the coating by the special combination of alkyd resin-solvent.

In summary, the use according to the invention enables not only cost savings to be implemented, e.g. lower energy and water consumption for cleaning, reduction of servicing and maintenance costs or reduction of wear and tear on the parts. Moreover, coated devices or components are generally contaminated to a lesser degree. In particular, e.g., in the case of devices that are difficult to access and therefore difficult to clean, such as, e.g. exhaust facilities, less contamination requiring less frequent cleaning reduces the workload significantly. And lastly, another essential aspect is that the occupational safety is increased since the water pressures used for cleaning are markedly lower than according to the prior art.

A typical formulation that can be used in the scope of the invention e.g. has the following composition: Alkyd resin 39%, organic calcium sulfonate 22%, white spirit 27.8%, cobalt octoate 0.1%, microwax 5%, paraffin 5%, and butanone oxime 0.1%

Table 1 summarizes again the mandatory and the optional components contained in the composition as well as their possible concentration ranges for use.

TABLE 1

| | Individual compo- | | |
|---|---|---|---|
| | nents of the formu- | | |
| No. | lation | Generic term | Range |
| 1 | Urethane oil | Alkyd resins | 20-60% by |
| | | | weight |
| 2 | Organic calcium | Sulfonates | 10-30% by |
| | sulfonate | | weight |
| 3 | White spirit | Aliphatic hydrocarbons | 10-50% by |
| | | | weight |
| 4 | Cobalt octoate | Drying agent | <1% by weight |
| 5 | Micro-wax | Wax | 1-10% by |
| | | | weight |
| 6 | Paraffin | Paraffins | 1-10% by |
| | | | weight |
| 7 | Butanone oxime | Anti-skinning agent | <1% by weight |

A formulation was prepared according to the specifications shown in the table. The concentration of the components was freely selectable within the specified range in each case as a function of the desired properties. An increase in the fraction of alkyd resin leads, e.g., to a more durable coating, whereas, e.g., a high wax content improves the anti-adhesion properties of the coating.

The preparation involved mixing the specified components at elevated temperatures of up to 120° C. In order to test the formulation, gratings and walking grids of a paint finishing line were coated with the composition by immersing. Depending on the surface consistency of the devices, other coating methods are conceivable as well, e.g. spraying or priming, etc. The devices and/or objects thus coated were used for approx. 5 shifts of 8 h each in the painting operation. After this followed a simple cleaning using a water jet at pressures between 120 and 500 bar. Initial tests carried out by the applicant demonstrated the durability of the coating for at least 20 cleaning cycles. In this context, the durability depends essentially on the pressure of the water jet that is used and the degree of contamination.

1-13. (canceled)

14. A method for improving the cleanability of a surface, the method comprising coating the surface with a wax-containing composition comprising:
alkyd resin as a binding agent at a concentration in the range of 20% to 60% by weight;
sulfonate at a concentration in the range of 10% to 30% by weight;
wax at a concentration in the range of 1% to 10% by weight; and
aliphatic hydrocarbon-based solvent at a concentration in the range of 10% to 50% by weight.

15. The method according to claim 14 wherein the concentration of alkyd resin in the composition is between 35% and 50% by weight.

16. The method according to claim 14 wherein the alkyd resin is a urethane oil.

17. The method according to claim 14 wherein the concentration of sulfonate in the composition is between 15% and 25% by weight.

18. The method according to claim 14 wherein the sulfonate contains organic calcium sulfonate.

19. The method according to claim 14 wherein the concentration of solvent in the composition is between 20% and 30% by weight.

20. The method according to claim 14 wherein the solvent is white spirit.

21. The method according to claim 14 wherein the concentration of wax in the composition is between 2% and 6% by weight.

22. The method according to claim 14 wherein the wax is a micro-wax having a melting range of 60° C. to 90° C., a paraffin wax having a solidification range of 50° C. to 90° C. and/or a polyethylene wax having a melting range of 95° C. to 135° C.

23. The method according to claim 14 wherein the composition further comprises a drying agent for the alkyd resin at a concentration of less than 1% by weight.

24. The method according to claim 23 wherein the drying agent is cobalt octoate.

25. The method according to claim 14 wherein the surface coated with the composition is on a device used in paint finishing lines, enameling rooms or enameling stations.

26. The method according to claim 14 wherein the surface coated with the composition is an internal wall of an exhaust air plant or duct.

27. The method according to claim 14 wherein the surface coated with the composition is on a device used in forming processes for plastic materials.
